(19) United States
(12) Patent Application Publication
(10) Pub. No.: US 2007/0143307 A1
(43) Pub. Date: Jun. 21, 2007

(54) Communication system employing a context engine

(76) Inventors: Matthew N. Bowers, Dallas, TX (US); John A. Moore, Carrollton, TX (US)

Correspondence Address: SLATER & MATSIL, L.L.P., 17950 PRESTON RD, SUITE 1000, DALLAS, TX, 75252-5793, US

(21) Appl. No.: 11/640,039

(22) Filed: Dec. 15, 2006

Related U.S. Application Data
(60) Provisional application No. 60/750,705, filed on Dec. 15, 2005.

(51) Int. Cl. G06F 17/30

(52) U.S. Cl. 707/10

(57) ABSTRACT

A communication system employable with a communication device coupled to an E-commerce database via a communication network, and method of operating the same. In one embodiment, the communication system includes an input engine configured to receive a query from the communication device directed to the E-commerce database. The communication system also includes a context engine configured to create a database representation of information within the E-commerce database and generate a representation of the query to match the information in the database representation. The communication system further includes a commerce portal browser configured to access and deliver an associated web page from the E-commerce database based on the match with the database representation. The communication system still further includes a response engine configured to process the associated web page and provide a response in a format consistent with the communication device based thereon.

This application claims the benefit of U.S. Provisional Application No. 60/750,705 entitled “One Click to Commerce,” filed Dec. 15, 2005, which application is incorporated herein by reference.

### CROSS-REFERENCE TO RELATED APPLICATIONS

This application is related to U.S. Patent Publication No. 2003/00185040 entitled “System and Method for providing Requested Information to Thin Clients,” to Volpi, et al., filed Jul. 17, 2002, U.S. Patent Publication No. 2004/0174900 entitled “Method and System for Providing Broadband Multimedia Services,” to Volpi, et al., filed Mar. 5, 2004, and U.S. Patent Publication No. 2006/0171402 entitled “Method and System for Providing Broadband Multimedia Services,” to Moore, et al., filed Jan. 6, 2006, which applications are hereby incorporated herein by reference.

### TECHNICAL FIELD

The present invention is directed, in general, to communication systems and, more specifically, to a multimedia communication system for network infrastructures to support mobile commerce.

### BACKGROUND

Presently, individuals seeking mobile commerce related content and information face significant challenges in migrating through existing database hierarchies and structures. The proliferation of types and quantities of content has served to exacerbate the problem by increasing the amount of information addressed by the end user. Present search related solutions often result in overloading the user with too much data and also do not address the voice related query market.

The mobile commerce market is growing rapidly with the advent of digital products such as ring tones, graphics, and games. Recently, there has been much activity focused on enabling individuals to interface with the Internet or mobile commerce databases via communication devices. Wireless access can bring the power of the Internet and commerce to a user on a wherever, whenever, and whatever basis. While the concept is good, it is also fundamentally flawed, as the necessary limitations of communication devices will only exacerbate the situation described above. As a result, there is a substantial unmet need in the market.

While service providers would like to offer more and different types of content for users to purchase via their communication devices, the systems presently in place are fuindamentally limited for several reasons. One reason is that the Internet and mobile commerce databases provide too much information. Users often find it difficult and cumbersome to get to the desired content frequently having to navigate numerous layers to reach the contents location in order to review or buy such information. For example, a simple search query can easily return several hundred or thousands of responses. Advanced searches that are often used to reduce the number to a manageable level is time consuming and difficult on communication devices and still produces unsatisfactory results. In addition, the searching is incompatible with spontaneous interaction and does not address an end user's option for voice related interaction with the referenced mobile commerce databases.

Another reason for the aforementioned limitation is that even though the information needed is in a specific database or location, the information is only useful when it is easily and quickly accessible, compatible with the capabilities of the communication devices (e.g., Palm OS, Symbian OS, and Microsoft OS), and accurate. Typically, when users query the mobile commerce database for particular content, the user receives large amounts of raw data that then requires another action, and another action, and so on until the desired location is reached.

For example, a personal digital assistant (“PDA”) or smart phone has both viewing and input limitations. One obvious limitation is that the screen on the PDA or smart phone cannot display as much information as on an office computer system, so too many search results become problematic to review. Another problem associated with a PDA or smart phone is the size of the keyboard. The keyboards of the PDA and smart phone may not have a full keyboard and, as such, are harder to use. The aforementioned limitation becomes exacerbated for an individual in a non-office environment where there are fewer resources available. In this situation, the individual would have to rely mostly on what the wireless communication device can effectively provide. Current systems do not effectively allow users of PDAs and smart phones to easily find information while providing an output consistent with the capabilities thereof and again the systems do not address the capability to search via voice related means.

Similar needs beyond those for mobile commerce related digital content also exist for individuals. These needs are exemplified, but not limited to medical records, insurance records, financial records and similar items. The needs for individuals can also be extended to agricultural items including livestock.

Additionally, it was well understood that the human voice is the preferred interface for communications. This, of course, led to the invention of the telephone, but the current needs extend far beyond human to human communications. The current needs are to invoke a wide variety of actions across any one of many networks using various communication devices. The ultimate goal continues to be natural language, speaker independent voice control of any communication device or process anywhere in the world. This goal and objective has had a number of obstacles that generally fall within two categories. The first category is the ability to achieve highly accurate speaker independent voice recognition across a wide range of communications networks. The second category is the ability to achieve natural language control of a process or finction.

Speaker independent voice recognition is possible using a number of presently available voice recognition engines (“VRE”). The degree of accuracy that can be achieved is dependant on many variables including the specific design of the VRE, the algorithms utilized and the number and specific languages. In most cases, the quality of the input human voice pattern to the VRE is one of the largest variables in the accuracy achieved.

Speech recognition is most useful when a very powerful computer is used to run the speech recognition application. This is most feasible by locating the VRE at a centralized location and sharing it across many users. The drawback is the quality of voice signal delivered to the VRE is then dependant on the communication devices and networks used for the delivery. Each type of network has its own specific limitations, but the following are some of the better known issues.

Wired access networks such as those used for traditional phone service, also referred to as the public switched telephone network (“PSTN”), are designed using engineering guidelines that originated in the 1930s. These design guidelines were developed to create consistent quality at a reasonable cost. As with any engineering design, there are specific limitations introduced by following the guidelines. For the PSTN in the United States, the maximum transmitted voice band is from 100 Hz to 4,000 Hz. This limitation was created by the use of inductive loading of the copper pairs between the user's location and the serving central office. With the introduction of digital carrier systems in the early 1960s, this limitation was extended to the connections between central offices. The pulse code modulation (“PCM”) used in standard carrier systems was limited to 56 Kb and later to 64 Kb per channel, which established an upper voice band at 4,000 Hz. The resulting delivered voice quality is the standard for human communications worldwide, but the detail nuances of speech, which improve the accuracy of speech recognition, are missing from the signal delivered across a network.

Wireless access networks have even more stringent limitations. The limiting asset of a wireless network is the radio frequency spectrum available to be shared by the users in a given geographic area. Regardless of the radio protocol, the objective of the network designers is to balance the spectrum used by each user against the cost of delivering a given quality of service. The bandwidth available for any user at a specific place and time is usually 13 Kb or less. This is not enough bandwidth to support intelligible voice using PCM technology. Wireless networks use advanced signal processing algorithms in voice coder/decoders to reduce the required bandwidth while still delivering acceptable speech quality. This quality is normally acceptable to the human ear, but is insufficient to capture the nuances of individual speech required by a VRE.

Voice over Internet Protocol (“VoIP”) is a newer method for communicating and, while it doesn't have the same limitations as the circuit switched PSTN, it certainly has its own constraints. A packet based network does not use a dedicated end to end channel for a given communication and there are inherent delays and other issues, which must be controlled in order to deliver an acceptable voice quality. Again, this quality is usually acceptable to the human ear, but it often falls far short of the quality needed for highly accurate speech recognition.

What is needed in the art, therefore, is a system and method that delivers services and applications to communication devices such as wireless communication devices that overcomes the deficiencies of the prior art and addresses the situations as mentioned above.

### SUMMARY OF THE INVENTION

To address the aforementioned limitations, the present invention provides a communication system employable with a communication device coupled to an E-commerce database via a communication network, and method of operating the same. In one embodiment, the communication system includes an input engine configured to receive a query from the communication device directed to the E-commerce database. The communication system also includes a context engine configured to create a database representation of information within the E-commerce database and generate a representation of the query to match the information in the database representation. The communication system further includes a commerce portal browser configured to access and deliver an associated web page from the E-commerce database based on the match with the database representation. The communication system still further includes a response engine configured to process the associated web page and provide a response in a format consistent with the communication device based thereon.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a diagram of an embodiment of an end-to-end network architecture including a communication system constructed according to the principles of the present invention;

FIG. 2 illustrates a diagram of another embodiment of an end-to-end network architecture including a communication system constructed according to the principles of the present invention; and

FIG. 3 illustrates a block diagram of a hierarchy of a mobile commerce website constructed according to the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The communication system (also referred to as “system”) and method of the present invention provides an architecture and system that is capable of receiving requests in multiple formats (e.g., multiple voice and/or data types) and act on those requests by delivering the user a preferable (e.g., the closest possible) location to purchase the desired content or achieve other desired personal or business desires. The system is compatible with a plurality of wireless and wired networks for carrying multimedia content to a variety of communication devices such as remote access terminals and devices. The system is employable with a multitude of networks including, without limitation, global system for mobile communication (“GSM”), general packet radio services (“GPRS”), enhanced data GSM environment (“EDGE”), universal mobile telecommunications service (“UMTS”), code-division multiple access (“CDMA”), evolution data only (“EVDO”), evolution data voice (“EVDV”), integrated digital enhanced network (“iDEN”), wireless fidelity (“Wi-Fi”), WiMAX, satellite communications (“SATCOM”), public switched telephone network (“PSTN”) and the Internet. Of course, any combination of mobile wireless, fixed wireless or wired networks may be employed in conjunction with the systems of the present invention.

The system of the present invention cooperates with a communication device to modify how the network treats the transaction being conducted based on predetermined business logic. As an example, once a user invokes a certain application from their communication device, a message is sent to a switching office or an equivalent thereof to request special treatment. The message identifies that the communication should employ non-standard treatment and that the network should determine the available allocation of resources based on specific service logic.

The system determines the bandwidth resources available at that specific time and place, which may be allocated to a specific user for a service request. In addition, the system determines a preferable voice coder pair available in the communication device and the network. The communication device is directed to use the selected voice coder and the network is directed to reserve the appropriate bandwidth for the communication. The allocation of the specific coder and bandwidth to the communication enhances the quality of voice information for signal repair and subsequent speech recognition subsystems. The system links the voice signal content to a signal repair subsystem. The direct connection implies that the voice signal is not decoded and recoded leading to quality degradation.

The system and method of the present invention will hereinafter be described with respect to preferred embodiments in a specific context, namely, in the environment of a communication network and related methods of delivering multimedia services. The principles of the present invention, however, may also be applied to other types of access points and controllers employable with network architectures. The advantages associated with the system further exploit the benefits associated with mobile commerce by connecting to a plurality of wireless and wired networks for carrying multimedia content to a variety of communication devices such as remote access terminals and devices. In accordance therewith, the present invention provides a system and method for providing mobile commerce to a plurality of communication devices through a plurality of access networks, both wired and wireless.

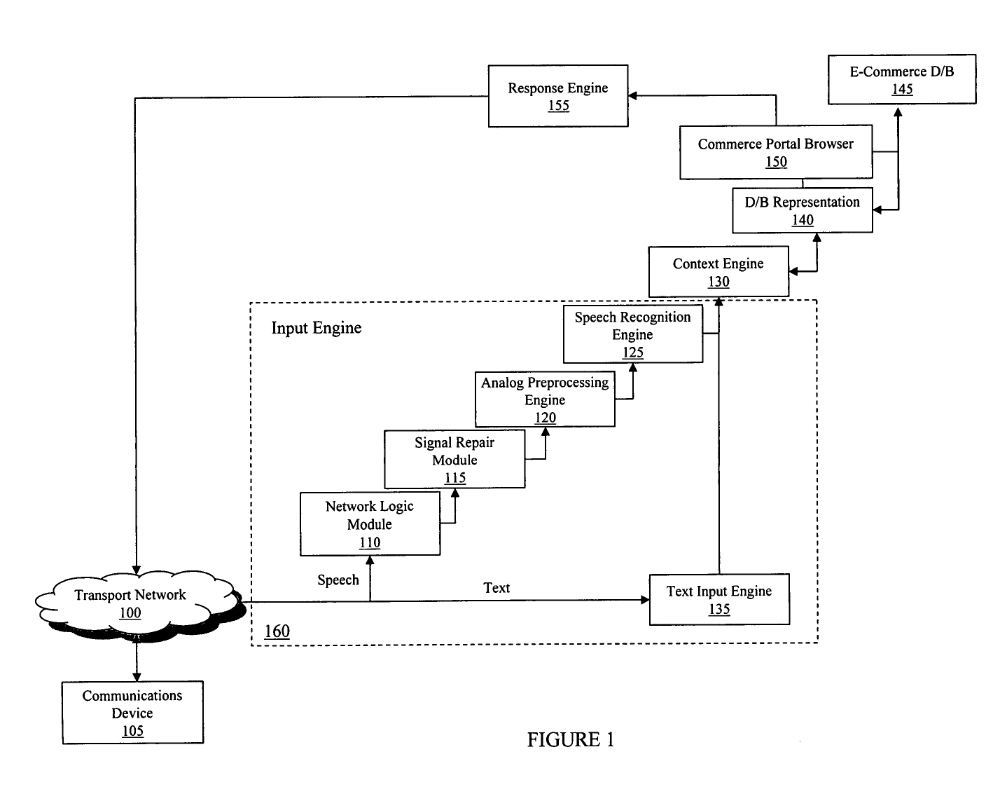

Referring initially to FIG. 1, illustrated is a diagram of an embodiment of an end-to-end network architecture including a communication system constructed according to the principles of the present invention. As mentioned above, mobile commerce is growing rapidly. Service and content providers would like to effectively offer more and different types of content. While the providers are becoming less hindered by wireless bandwidth, the communication devices are causing significant challenges for users to quickly and easily find the desired content. This is becoming a greater issue with the proliferation of offerings. The communication system is capable of receiving requests in multiple formats (e.g., multiple voice and/or data types) and acting on the requests by delivering the user to preferably the closest possible location to purchase the desired content or achieve other desired personal or business desires, thereby addressing the aforementioned challenges.

The network architecture includes a transport network (also referred to as “network” and “access network”) 100 coupled to a communication device 105 with a user interface. The communication device 105 may be any variety of fixed, portable or mobile communication devices including cellular phones, smart phones, personal computers and other kinds of communications and computing devices. The communications device 105 may operate with one or more access networks 100 and the signaling and control protocols will be specific to the standards for each specific network 100. A user interface of the communication device 105 typically resides thereon and functions as an input/output (“I/O”) interface to any application/service or other communication device. The application/services invoked may reside on the device 105, but also may be resident in the network as an application/service or some combination thereof, which the communication device interacts with to accomplish a particular task. The application may invoke a graphical user interface or other user interface designs and may be programmed in variations of C, NET, Java or other programming languages. The communication device 105 coupled with the user interface is designed to allow a user to interact with the application/service to most effectively achieve the desired task. An example of this would be to interact with an e-commerce location to purchase music, games, graphics or other digital content. A high quality user interface that takes into consideration human factors based on the communication devices 105 input and communication capability is preferable to the overall success of the system (including the usability by the user).

While there are no limits to the types of inputs the user interface can handle, the two primary means of input are likely to be various forms of speech and text. Speech may be delivered via normal cellular communications, push to talk, VoIP, a forwarded recorded voice file, or other types of voice communications. Additionally, text input may be employed with the communication device 105. Some sample types of text input include via a web interface [e.g., wireless application protocol (“WAP”), hypertext markup language (“HTML”), extensible markup language (“XML”)], short messaging service (“SMS”), multimedia messaging service (“MMS”), instant messaging (“IM”) or any other possible mechanism. The communication system delivers the input to the application/service via the network of choice. As there are multiple types of networks and current and future communication devices 105 are or will be capable of accessing them simultaneously. As mentioned above, any flavor of transport network 100 may be employed by the communication device 105.

While a communication device 105 associated with a cellular communications network 100 already interacts with that network 100 to function properly, there will be an opportunity to modify the way the communication device 105 interacts therewith to improve the amount of voice data that is transferred over the network 100. The modification of the normal voice content or query transmitted by the communication device 105 through the network 100 is controlled or directed by a network logic module 110 as set forth below.

In relation to the use of voice or speech, the network logic module 110 is resident within or without the communication device 105 that modifies how the network 100 treats the speech query or transaction being conducted based on a set of predetermined logic or business logic. As an example, once the communication device 105 invokes a certain application, a message is sent to the mobile switching center (“MSC”) or other location as necessary. The message specifies that the value of the transaction is high and that if this were a voice call the highest rated available voice coder (such as an adaptive rate vocoder) is invoked thereby ensuring that the preferable amount of voice information is used in the system specified herein. It is possible that a very high quality vocoder would be invoked beyond any which is utilized for normal communications. If the communications network 100 is a high bandwidth data network capable of transmitting voice over internet protocol such as WiFi 802.11a/b/g/n etc or WiMax 802.16, the request for service would result in the network logic module 110 assigning a very high quality voice signal processor in the communications device 105. An example might be an advanced MPEG 4 audio coder AAC, which would deliver a voice bandwidth equivalent to a 20 KHz audio signal. If the communication is a text or data session, then a high quality of service (“QoS”) is applied to improve the transmission of text or data between the communication device 105 and a text input engine 135 across the communication network 100 and the likelihood of a successful transaction.

In addition, depending on the implementation of the system, the MSC or other network controller location as necessary specifies the delivery of the information that was vocoded on the communication device 105 to be delivered in its integral vocoded state to a predetermined location for processing (i.e., the network logic module 110). This is important to the success of the communication system because it increases the amount of speech related information received from the user as well as reduces the data loss created through multiple voice coding and decoding events. The network logic module 110 may deliver raw voice coder bits to a signal repair module 115 or deliver raw voice coded bits to a decoder before the signal repair module 115.

The signal repair module 115 repairs voice communications by their very nature that have been degraded due to noise, network issues and a variety of other influences. The signal repair module 115 evaluates the voice communications and repairs the fidelity thereof to dramatically improve the quality of the communications. This technology, in addition to how it is utilized here, can be applied in various parts of the transport network 100 and communication device 105 to improve voice quality. The repaired and improved voice communications are then fed to a speech recognition engine 125 via an analog preprocessing engine 120, which is a speech optimization application. The signal repair module 115 improves the amount and clarity of the speech related information that can be input into the speech recognition engine 125 creating higher quality results.

Thus, the signal repair module 115 is designed to accept standard digital voice signals from the transport network 100 directly or inputs as a result of the processing completed by the network logic module 110. The signal repair module 115 then evaluates the digital signal for loss of fidelity due to a variety of factors including, but not limited to, noise and vocoder/devocoder issues and then does anticipatory repair of the auditory signal. The improved fidelity is then delivered in the same standard digital voice format it was received in to either the analog preprocessing engine 120 for further enhancement or to the speech recognition engine 125. An example of signal repair systems and subsystems, see U.S. Pat. No. 6,931,292 entitled “Noise Reduction Method and Apparatus,” to Brumitt, et al., issued Aug. 16, 2005, which is incorporated herein by reference.

The analog preprocessing engine 120 is designed to act as an intermediary between direct voice communications or voice communications processed by signal repair module 115 and speech recognition engine 125. The analog preprocessing engine 120 formats the incoming speech into a format preferable by the speech recognition engine 125. While adjustments could take on a wide variety of forms, a simple example would be to slow down the incoming speech to a predetermined speed with predetermined separation of words (e.g., 0.25 seconds). The preprocessing improves the accuracy rate (output) of the speech recognition engine 125 by normalizing the speech in a way to improve the ability for the speech recognition engine 125 to understand it. In general, the analog preprocessing engine 120 modifies a format of a speech query from the communication device 105.

Thus, the analog preprocessing engine 120 is designed to accept standard digital voice content from the transport network 100, the network logic module 110, or from the signal repair module 115. The analog preprocessing engine 120 evaluates the voice related content and through various methods, including but not limited to, speeding up or slowing down delivery of the voice content, increasing or decreasing the volume of the voice content, and increasing or decreasing the space between the individual words or phrases in the voice content optimizes it for delivery to the speech recognition engine 125.

The speech recognition engine 125 evaluates the speech and outputs a standard data format (e.g., text and XML) for delivery to a context engine 130. The system may use speech as one of the mechanisms by which to input a query and speech may be an important element in an environment with challenging data input mechanisms. The speech recognition engine 125 is also capable of differentiating multiple languages (e.g., English, Spanish and Japanese). The speech recognition engine 125 may also transform the speech to text format for use by the context engine 130.

The context engine 130 evaluates the output from the speech recognition engine 125 and/or data/text input coming from the communication device 105. The context engine 130 evaluates that context against set information that it has already evaluated and characterized (e.g., e-commerce website/portal) to determine the relevant location to deliver to the communication device 105. The context engine 130 performs in real time and also includes a feedback loop to improve the accuracy of the results automatically. The context engine 130 mitigates the inherent inaccuracy of speech processing systems and understands the meaning without having to understand all of the underlying text or language. The context engine 130 should preferably generate accuracy of greater than 99% in understanding context, which is critical (>94%) for moving through complex multi-tiered information structures. The context engine 130 can also handle any language. The context engine 130 also reduces poor speech recovery accuracy issues and reduces the user independent, natural language concept recognition accuracy. The context engine 130 may also be formed using multiple context engines. Exemplary concept related search tools are disclosed in U.S. Pat. No. 4,839,853, entitled “Computer Information Retrieval Using Latent Semantic Structure,” to Deerwester, et al, issued Jun. 13, 1989 and “Indexing by Latent Semantic Analysis,” Journal of the American Society for Information Science, Vol. 41, No. 6, pp. 391-407 (1990), which are incorporated herein by reference.

For a better understanding of search engines and other related engines, in general, see U.S. Pat. No. 6,775,677, entitled “System, Method, and Program Product for Identifying and Describing Topics in a Collection of Electronic Documents,” to Ando, et al., issued Aug. 10, 2004, U.S. Patent Publication No. 20030004942, entitled “Method and Apparatus of Metadata Generation,” to Bird, published Jan. 2, 2003, U.S. Patent Publication No. 20040064438, entitled “Method for Data and Text Mining and Literature-Based Discovery,” to Kostoff, published Apr. 1, 2004, U.S. Patent Publication No. 20020103799, entitled “Method for Document Comparison and Selection,” Bradford, et al., published Aug. 1, 2002, U.S. Patent Publication No. 20040220944, entitled “Information Retrieval and Text Mining Using Distributed Latent Semantic Indexing,” to Behrens, et al., published Nov. 4, 2004, U.S. Pat. No. 6,772,170, entitled “System and Method for Interpreting Document Contents,” to Pennock, et al., issued Aug. 3, 2004, U.S. Patent Publication No. 20040059736, entitled “Text Analysis Techniques,” to Willse, et al., published Mar. 25, 2004, U.S. Patent Publication No. 20040210443, entitled “Interactive Mechanism for Retrieving Information from Audio and Multimedia Files Containing Speech,” to Kuhn, et al., published Oct. 21, 2004, U.S. Pat. No. 5,278,980, entitled “Iterative Technique for Phrase Query Formation and an Information Retrieval System Employing Same,” to Pedersen, et al., issued Jan. 11, 1994, U.S. Patent Publication No. 20020103809, entitled “Combinatorial Query Generating System and Method,” to Starzl, et al., published Aug. 1, 2002, which are incorporated herein by reference.

The context engine 130 receives inputs and employs one or more methods to determine the relevance of and map the input to a particular place within one or more database representations (see below). The context engine 130 typically uses two or more of the following methods to get highly accurate results, namely, “context switching” which is a highly accurate method of determining if something “is” or “is not” like something else; and “concept space” which maps how every concept with a set of information is related to every other concept and the relative weighting between them and “key word” search found in most search engines today. The interaction and correlation between the methods generates a statistical number that is associated with a point or location within the database representation.

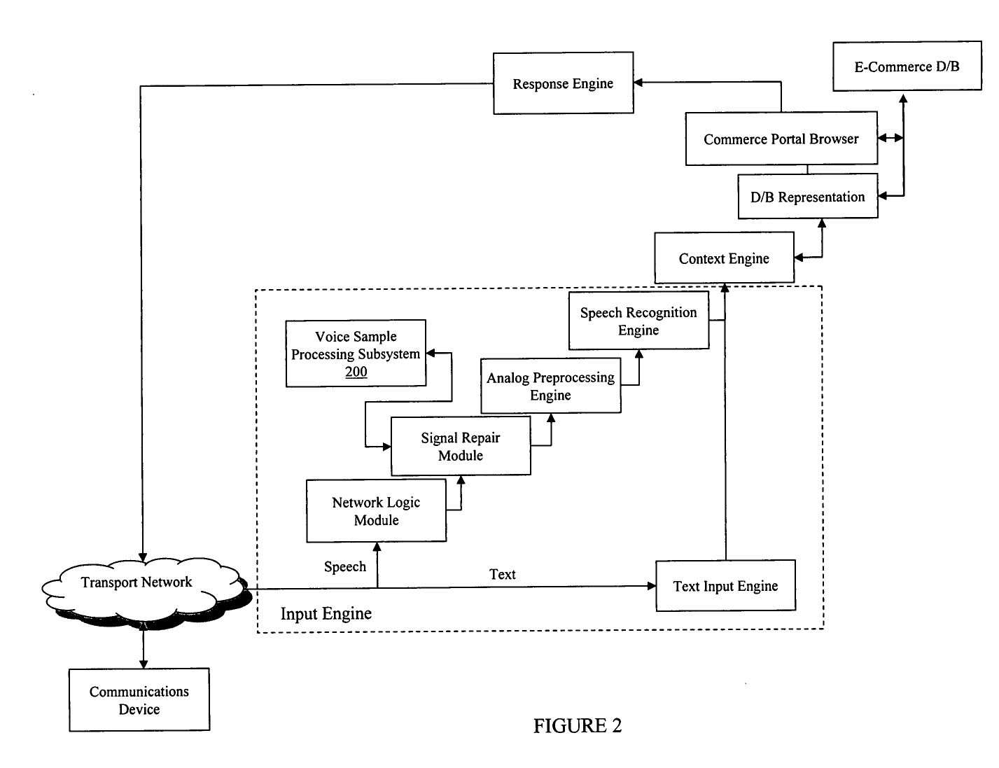

Regarding text communications, a query in the form of the text is input to the text input engine 135 and thereafter provided to the context engine 130. The text input engine 135 can accommodate any text type or input mechanism such as a web interface, SMS, to name a few. Other interfaces are also within the broad scope of the present invention and may be provided via the transport network 100 to the context engine 130. The network logic module 110, signal repair module 115, analog preprocessing engine 120, speech recognition engine 125 and text input engine 135 form an input engine 160. The input engine 160 may invoke specific subsystems, modules and engines therein, as necessary, depending on the type of input from the communication device 105 and the quality of the signal associated therewith. Additionally, the input engine 160 may be augmented with additional capabilities (see, e.g., the description with respect to FIG. 2) or omit specific subsystems, modules and engines therein depending on the application.

The context engine 130 creates a database representation/characterization (also referred to as “database representation” or “representation” or “D/B representation”) 140 of a particular information set. In this case, the database representation 140 is an e-commerce website/portal/database, which assists the context engine 130 understand the relationship between different elements inside that database to properly route the user to the most appropriate location with respect to a given transaction. The database representation 140 is created by training the context engine 130 with information that is relevant to each item the user would like it to be “smart” on. This information can take many forms including Microsoft word documents, Adobe acrobat files, and numerous other types of input types and including data and natural language. The communication system also constantly evaluates and refines its understanding based on new information that it receives on the subject. This new information can be manually fed to the communication system, a result of the normal operations/interaction of the communication system, automatically programmed to receive information (e.g., a real simple syndication) or can seek information when the communication system determines the system does not have the proper information. This is extremely important as it works with and enables the context engine 130 to accurately place the user in the closest location possible to their desired transaction in the multi-tiered information structure. The context engine 130 and the database representation 140 provides an automated feedback loop for a training process and the like with an E-commerce database (also referred to as “E-commerce D/B”) 145 (e.g., music, pictures, video).

The database representation 140, therefore, is a mathematical or statistical representation of selected information and concepts within an E-commerce database 145 plus additional added information as desired to magnify or optimize the concept. The database representation 140 is created by the context engine 130 by creating files on each concept, inputting relevant information on that file, and having the concept engine 130 conduct a training process. The result is a mathematical or statistical evaluation of that file or concept and a relative statistical evaluation to all the other files or concepts within the database representation 140. The database representation 140 can be modified on a manual or automatic basis providing for automated improvement of its accuracy. The database representation 140 is coupled with the E-commerce database 145 for conducting actual transactions by a commerce portal browser 150.

The communication system also includes a commerce portal browser 150 provides a vXML/XML browser or speech portal links and speech enables existing applications and/or services. An example is a unified customer service. In this example, a user could either go to a website, call an agent or work through and an interactive voice response (“IVR”) system to achieve the same goal. The commerce portal browser 150 provides a mechanism to trigger events and choices, and provides feedback (prompts) to refine, verify and/or modify interaction with the communication system. The commerce portal browser 150 will be linked to the E-commerce database 145 and may be linked to the context engine 130 and the database representation 140. It is advantageous because it creates the speech framework around the multi-tiered information structure that enables a user to navigate effectively in the speech domain.

Thus, the commerce portal browser 150 provides the logic that translates between the database representation 140 and the E-commerce database 150 and also provides the logic for serving up the web pages or refining query options associated with the response from the user's query. The commerce browser portal 150 is capable of handling both speech and non-speech related requirements through, but not limited to, standards such as XML and vXML. The commerce portal browser 150 could be embodied by any number of web servers that have been customized to support the required business logic associated with this type of application. Once the context engine 130 receives the user's query, it generates a mathematical representation of that query and matches it the closest possible location match in the database representation 140. The commerce portal browser 150 then takes this location match and accesses and delivers the associated web page with the E-commerce database 145 to a response engine 155 for processing into a format acceptable to the communication device 105.

The E-commerce database 145 is typically an application or service. As an example, the E-commerce database 145 may be a website wherein communication devices 105 can access, review and purchase digital content such as ringtones, graphics or games. This, however, could be any application or service that needs automation and simplification of access. The E-commerce database 145 may be any commerce or other type of website that has associated information or content that someone or something might want to access or purchase. For purposes of this invention any website and associated database structure is acceptable.

The communication system also includes a response engine 155 that delivers responses to the communication device 105 based on their queries. The response may be sent in a variety of formats including text responses such as SMS messages, web pages, WAP pages, MMS messages, and IM messages. A text response may also be transformed to a speech response by a text to speech engine within the response engine that delivers similar information to the user, but in a voice environment. The communication system allows interaction with the communication device and, more importantly, in a way that is acceptable to the user from an ease of use perspective. Additionally, preset prompts in the form of voice or text can be sent to the communication device 105 via the response engine 155.

The response engine 155 is designed to process the web pages served up by the commerce portal browser 150 and the E-commerce database 145 and modify them for delivery in various forms as desired by the user of the system. This includes formatting the response to match the user's, via the communication device 105, desired receipt method including, but not limited to, text response via SMS, IM, and E-mail, voice response via text to speech capabilities, and multimedia including, but not limited, to WAP and MMS.

Turning now to FIG. 2, illustrated is a diagram of another embodiment of an end-to-end network architecture including a communication system constructed according to the principles of the present invention. In addition to the subsystems, modules and engines illustrated and described with respect to FIG. 1 above, the communication system includes voice sampling processing subsystem 200 as part of an input engine. In conjunction with the signal repair module, the voice sampling processing subsystem 200 evaluates voice patterns to verify a user's identity against a pre-defined database of that user's voice characteristics. This technique would be used in conjunction with a communication device's unique identifier [e.g., a subscriber identity module (“SIM”) card] and/or a personal identification number (“PIN”) to create two or three factor authentication. This may be beneficial for security purposes especially in scenarios that include, without limitation, financial transactions. The voice sampling processing subsystem 200 typically includes a processor and voice sample database to perform its intended purpose.

The voice sample processing subsystem 200 is a similar implementation to that of the context engine and the database representation as described with respect to FIG. 1. In this case, however, the database representation is a mathematical representation of one or more samples of voice information on each person within the database. The database representation on each individual is then matched against an person trying to access a particular feature or application within the context of the system. If the mathematical representation housed within the database representation is a match of the input when the user is using, the system the user will be enabled to continue with their transaction. This authentication mechanism can be used as an active or passive second or third factor of security and authentication when used with a SIM card or personal identification number.

The communication system can employ logical parameters associated with a specific communication to direct the network to utilize more network resources for that specific communication. The logical parameters may include the specific service requested, the specific user's subscribed services, or the communication device's capabilities. The greater resource allocation can be used to improve the quantity or quality of the information communicated from the communication device to the elements of the communication system and the network. The logical parameters associated with a specific communications request can be used to direct the end to end allocation of communication system to avoid signal degradation. The communication system can direct the communication device to utilize specific elements that will match the available network resources. The identity of the user can be used to modify the process from speaker independent to speaker dependant voice recognition with the objective of improving accuracy.

Regarding the communication system, there are two preferable means to input a request for a service. The most straightforward is using text. If a communications device has the ability to generate text such as an QWERTY keyboard on a personal computer or smartphone or it has an alpha-numeric keypad associated with a VoIP or cellular handset and the device has an access network that is capable of transmitting data, then the communication device can communicate with the system using text massages. The actual device interface and network could be WAP, SMS, MMS, IM a PC web browser or others but the text data would be transferred through the network and delivered to the text input engine.

The second possible means for providing the input is using speech, which can be far more complex. The user would request access to the service by invoking (dialing) a special service code. The request for service would be sent to the network logic module in the communication system. This network logic module would negotiate with the communication device and the network to determine the optimum voice coder and available bandwidth given the users device, location, access method, and requested service. As an example, the user has a communication device that has a VoIP interface and the network is capable delivering 6 Mb/s from the communication device to the serving network logic module through the network. The network logic module would find the highest quality voice coder available in the communication device and request the device to use this coder to generate the coded speech for delivery to the network logic module.

An alternative example would be a user in a cellular network. The dialed request for service would follow the same sequence but in this case the network logic module interrogates the communication device and determines it has an adaptive double rate voice coder that uses two radio time slots 32 kb/s gross rate rather than 16 kb/s gross rate. The network logic module then negotiates with the network to determine if two time slots are available for this user and location at this point in time. If this condition can be met then the network logic module would request assignment of the appropriate resources and match the received information to the appropriate voice decoder.

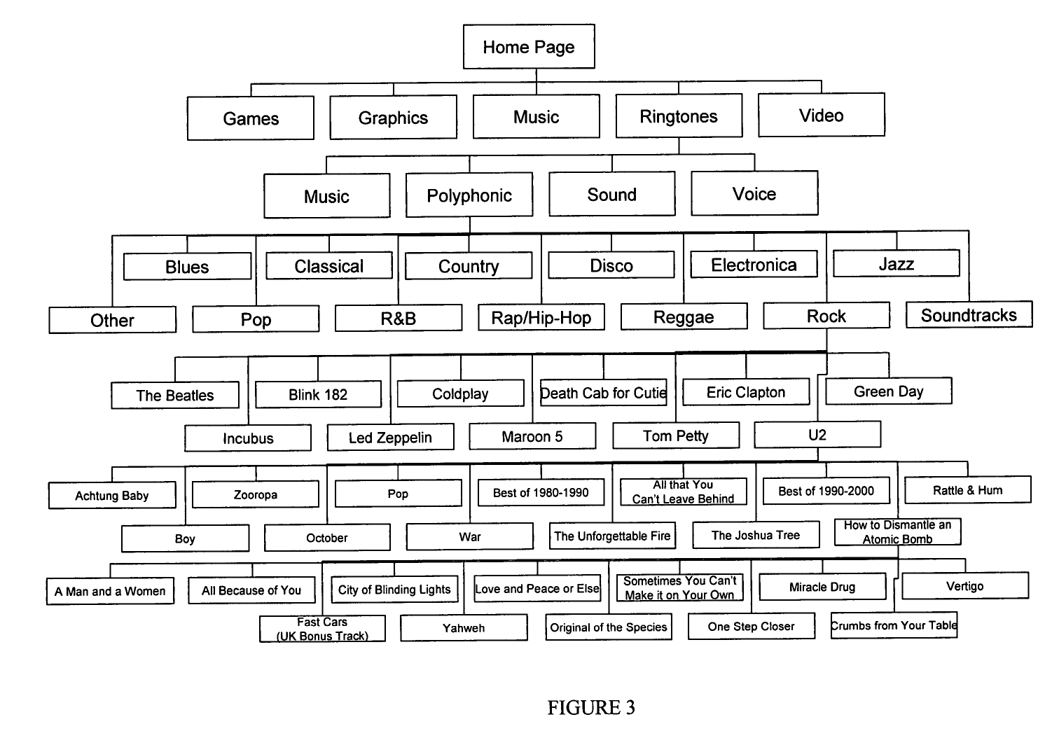

Turning now to FIG. 3, illustrated is a block diagram of a hierarchy of a mobile commerce website constructed according to the principles of the present invention. The mobile commerce website hierarchy is focused on consumer content and the levels of navigation to purchase desired content. The hierarchy highlights the various levels a user traverses to reach their desired location to retrieve the desired information or the desired content to purchase. This sample E-commerce hierarchy also highlights the complexity with regard to amounts of information as well as concepts that create significant limitations searching and accessing desired information. The hierarchy illustrates that once an E-commerce site is reached to access a particular piece of content, in this case a polyphonic ringtone, the user traverses six different layers including type of content, type of ringtone, genre of ringtone, artist, album and song. The system of the present invention resolves the aforementioned limitation by enabling a user through voice or text communication to input key words or a natural language query and the communication system will place the user at the closest possible location to the information or content they were seeking, removing significant requirements to traverse through the database hierarchy and layers of refining queries in the process of getting to the information or content the user is seeking.

With continuing reference to the foregoing FIGUREs, an exemplary operation of the communication system will hereinafter be provided. A first example contemplates a voice driven E-commerce transaction. Assuming that a user desires to purchase a ringtone from a mobile operator's content website using voice/speech, a method of operating the communication system will hereinafter be described. The user via a communication device 105 dials a specific telephone number associated with the mobile operators E-commerce database 145. In the process of dialing the number, the user accesses the speech recognition engine 125 coupled to the commerce portal browser 150 and response engine 155, collectively acting like to an interactive voice response (“IVR”) system, and is then prompted for action by the communication system (e.g., “You have accessed our entertainment content portal. How may I help you?”). The user would then make a request (e.g., “I would like to buy the song Vertigo”). Either prior to this occurring or from the prompt, the voice sampling processing subsystem 200 could be invoked to authenticate the user's capability to undertake the transaction. In the process of initiating the transaction, since the number used to access the E-commerce database 145 is known, and this is considered a high value transaction, the network logic module 110 would alter the logic in a network control element (e.g., MSC) to enable maximum rate vocoding available and specify the location closest to the final destination to be delivered and devocoded.

If available, this devocode location would occur just prior to entering the signal repair module 115. The signal repair module 115 would then take the delivered voice signal, which is of maximum quality available, and process, repair and enhance it and deliver it to the analog preprocessing engine 120. The analog preprocessing engine 120 would then take the improved signal from the signal repair module 115 and format it in a way that was optimum for the speech recognition engine 125 to ingest, process and determine the appropriate text or meaning. Once the text or meaning had been determined by the speech recognition engine 125, it would be fed into the context engine 130 for context processing and then matched against the most appropriate context in the database representation 140. If a highly correlated match was identified in the database representation 140, the commerce portal browser 150 would retrieve and serve up the matching location in the E-commerce database 145.

If no highly correlated match was identified, the commerce portal browser 150 would send a refining query to the user (e.g., “Were you looking for the movie or the song?” or “I am sorry I did not understand you, could you please repeat your request?”) and the process would continue until an appropriate match was found. The retrieved and served up page by the commerce portal browser 150 would then forward the path to the response engine 155 which would either pass through scripted items and/or use text to speech (“TTS”) technology to modify the choices or options (e.g., “Would you like to purchase Vertigo now?” or “Would you like to listen to a sample of the song Vertigo?”). The user would then provide a response and the communication system would complete the transaction.

Another example involves a WAP/text E-commerce transaction, wherein a consumer desires to purchase a ringtone from a WAP enabled mobile operator's content website utilizing text input as the method of interacting with the communication system. The user via a communication device 105 would access the appropriate E-commerce database 145 via hotkey, web address or some other means. Via a location to input text on the home page of the E-commerce database 145, the user would input a query directed to what they would like to buy or review. The input would then be fed into the context engine 130 for context processing and then matched against the most appropriate context in the database representation 140. If a highly correlated match was identified in the database representation 140, the commerce portal browser 150 would retrieve and serve up the matching location in the E-commerce database 145. If no highly correlated match was identified, the commerce portal browser 150 would, via text, send a refining query to the user (e.g., “Were you looking for the movie or the song?” or “I am sorry I did not understand you, could you please repeat your request?”) and the process would continue until an appropriate match was found. The identified page would then be retrieved and served up to the user by the commerce portal browser 150 for the user to execute a transaction via the response engine 155 using a text response.

Exemplary embodiments of the present invention have been illustrated with reference to specific electronic components. Those skilled in the art are aware, however, that components may be substituted (not necessarily with components of the same type) to create desired conditions or accomplish desired results. For instance, multiple components may be substituted for a single component and vice-versa. The principles of the present invention may be applied to a wide variety of network topologies.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A communication system employable with a communication device coupled to an E-commerce database via a communication network, comprising:
an input engine configured to receive a query from said communication device directed to said E-commerce database;
a context engine configured to create a database representation of information within said E-commerce database and generate a representation of said query to match said information in said database representation;
a commerce portal browser configured to access and deliver an associated web page from said E-commerce database based on said match with said database representation; and
a response engine configured to process said associated web page and provide a response in a format consistent with said communication device based thereon.

2. The communication system as recited in claim 1 wherein said input engine includes a text input engine configured to receive a text query from said communication device.

3. The communication system as recited in claim 1 wherein said input engine includes a network logic module configured to select a treatment of a speech query from said communication device based on a predetermined set of logic.

4. The communication system as recited in claim 3 wherein said network logic module is configured to invoke a high quality vocoder to code said speech query based on said predetermined set of logic.

5. The communication system as recited in claim 1 wherein said input engine includes a signal repair module configured to repair a fidelity of a speech query from said communication device.

6. The communication system as recited in claim 1 wherein said input engine, includes:
an analog preprocessing engine configured to modify a format of a speech query from said communication device, and
a speech recognition engine configured to transform said speech query into a text format for said context engine.

7. The communication system as recited in claim 1 wherein said input engine includes a voice sample processing subsystem configured to verify an identity of a user of said communication device against a predefined database of voice characteristics based on a speech query therefrom.

8. The communication system as recited in claim 1 wherein said context engine is configured to employ context switching and context matching to generated said representation of said query.

9. The communication system as recited in claim 1 wherein said context engine and said database representation are configured to provide an automated feedback loop for a training process with said E-commerce database.

10. The communication system as recited in claim 1 wherein said response engine is configured to transform said response from text to speech.

11. A method of operating a communication system employable with a communication device coupled to an E-commerce database via a communication network, comprising:
receiving a query from said communication device directed to said E-commerce database;
creating a database representation of information within said E-commerce database;
generating a representation of said query to match said information in said database representation;
accessing and delivering an associated web page from said E-commerce database based on said match with said database representation;
processing said associated web page; and
providing a response in a format consistent with said communication device based thereon.

12. The method as recited in claim 11 wherein said query is a text query from said communication device.

13. The method as recited in claim 11 wherein said query is a speech query from said communication device and said method comprises selecting a treatment of said speech query based on a predetermined set of logic.

14. The method as recited in claim 13 wherein said selecting includes invoking a high quality vocoder to code said speech query based on said predetermined set of logic.

15. The method as recited in claim 11 wherein said query is a speech query from said communication device and said method comprises repairing a fidelity thereof.

16. The method as recited in claim 11 wherein said query is a speech query from said communication device and said method, comprises:
modifying a format of said speech query, and
transforming said speech query into a text format.

17. The method as recited in claim 11 wherein said query is a speech query from said communication device and said method comprises verifying an identity of a user of said communication device against a predefined database of voice characteristics based on said speech query.

18. The method as recited in claim 11 wherein said generating said representation of said query includes employing context switching and context matching.

19. The method as recited in claim 11 wherein said creating, said generating and said accessing and delivering employ a training process with said E-commerce database.

20. The method as recited in claim 11 wherein said response is transformed from text to speech.
